(19) United States
(12) Patent Application Publication
(10) Pub. No.: US 2018/0007089 A1
(43) Pub. Date: Jan. 4, 2018

(54) NETWORK EVALUATOR

(71) Applicant: TELECOMMUNICATION SYSTEMS, INC., Annapolis, MD (US)

(72) Inventors: BRENDAN WATTERS, COLLEGE PARK, MD (US); PHILLIP STONER, GAMBRILLS, MD (US); MICHAEL TESSIER, ANNAPOLIS, MD (US); KYLE JARRETT, SILVER SPRING, MD (US)

(21) Appl. No.: 15/196,994

(22) Filed: Jun. 29, 2016

(51) Int. Cl. H04L 29/06; H04L 12/26

(52) U.S. Cl. CPC H04L 63/20; H04L 63/1425; H04L 43/50; H04L 63/0263

(57) ABSTRACT

A given network evaluator can be configured to execute a network test based on a test file. The execution of the network test can include attempting to establish bi-directional communication with another network evaluator over a network employing a plurality of different ports and protocols specified in the log file. The execution of the network test can also include recording a success or failure of the attempting in a log file.

### TECHNICAL FIELD

This disclosure relates to a network evaluator for testing a network.

### BACKGROUND

In computer technology, a firewall is a network security system that monitors and controls the incoming and outgoing network traffic based on predetermined security rules. A firewall can be employed to establish a barrier between a trusted, secure internal network and another outside network, such as the Internet, that is assumed to not be secure or trusted. Firewalls are often categorized as either network firewalls or host-based firewalls. Network firewalls are a software appliance running on general purpose hardware or hardware-based firewall computer appliances that filter traffic between two or more networks. Host-based firewalls provide a layer of software on one host that controls network traffic in and out of that single machine. Routers that pass data between networks contain firewall components and can often perform basic routing functions as well. Firewall appliances may also offer other functionality to the internal network they protect such as acting as a Dynamic Host Configuration Protocol (DHCP) and/or a Virtual Private Network (VPN) server for the network.

An access control list (ACL), with respect to a computer file system, is a list of permissions attached to an object, such a network node or switch. An ACL specifies which users or system processes are granted access to objects, as well as what operations are allowed on given objects. Each entry in a typical ACL specifies a subject and an operation.

### SUMMARY

One example relates to a computing device executing a given network evaluator, the given network evaluator being configured to execute a network test based on a test file. The execution of the network test can include attempting to establish bi-directional communication with another network evaluator over a network employing a plurality of different ports and protocols specified in the test file. The network test can also include recording a success or failure of the attempting in a log file.

Another example relates to a master network evaluator including one or more computing devices. The master network evaluator can be configured to receive a set of network rules that characterizes security settings of a network and architecture of the network. The master network evaluator can also be configured to generate a plurality of test files that each characterizes parameters for a series of network tests based on the network rules. The master network evaluator can further be configured to provide each of the plurality of test files to a respective client network evaluator of a plurality of client network evaluators. The master network evaluator can still further be configured to receive a plurality of log files that each characterizes a network test executed by each of the plurality of network evaluators.

Yet another example relates to a network that can include a master network evaluator including one or more computing devices. The master network evaluator can include network rules that define security rules of a firewall on the network and architecture of the network. The network can also include a given client network evaluator comprising a computing device that is in communication with the master network evaluator via the network, wherein the given client network evaluator is logically positioned in front of the firewall. The network can further include another client network evaluator comprising a computing device in communication with the master network evaluator, wherein the other client network evaluator is logically positioned behind the firewall. The master network evaluator can be configured to generate a given test file for the given client network evaluator based on the network rules. The given test file can define parameters for network tests for establishing communication with other network nodes over a plurality of different protocols and ports traversing the firewall. The master network evaluator can further be configured to generate another test file for the other client network evaluator based on the network rules. The given test file can define parameters for network tests for establishing communication with other network nodes over a plurality of different protocols and ports traversing the firewall. The master network evaluator can still further be configured to signal the given client network evaluator to execute a series of network tests based on the given test file and to signal the other client network evaluator to execute another series of network test based on the other test file.

### BRIEF DESCRIPTION OF THE DRAWINGS

FIG. 1 illustrates an example of a network with components for testing the security of the network.

FIG. 2 illustrates another example of a network with components for testing the security of the network.

FIG. 3 illustrates an example of a master network evaluator for testing a network.

FIG. 4 illustrates a flowchart of an example method for testing a network.

### DETAILED DESCRIPTION

This disclosure relates to components operating on a network for testing the security of the network. In one example, the network can include a master network evaluator implemented on one or more computing devices. The master network evaluator can include a set of network rules that define security rules of a firewall (or other security device) on the network and architecture of the network. The network can also include one or more client network evaluators that communicate (or are integrated with) the master network evaluator. The master network evaluator can generate test files for the client network evaluators. The client network evaluators can employ the test files to execute network tests on the network. The results of the network tests can be recorded in log files and returned to the master network evaluator.

The master network evaluator can aggregate and/or parse the log files to generate a security report for the network. The security report can identify security holes in the network and/or verify that expected points of ingress and egress of the network (e.g. in a firewall or an access control list (ACL) of a switch) are configured properly.

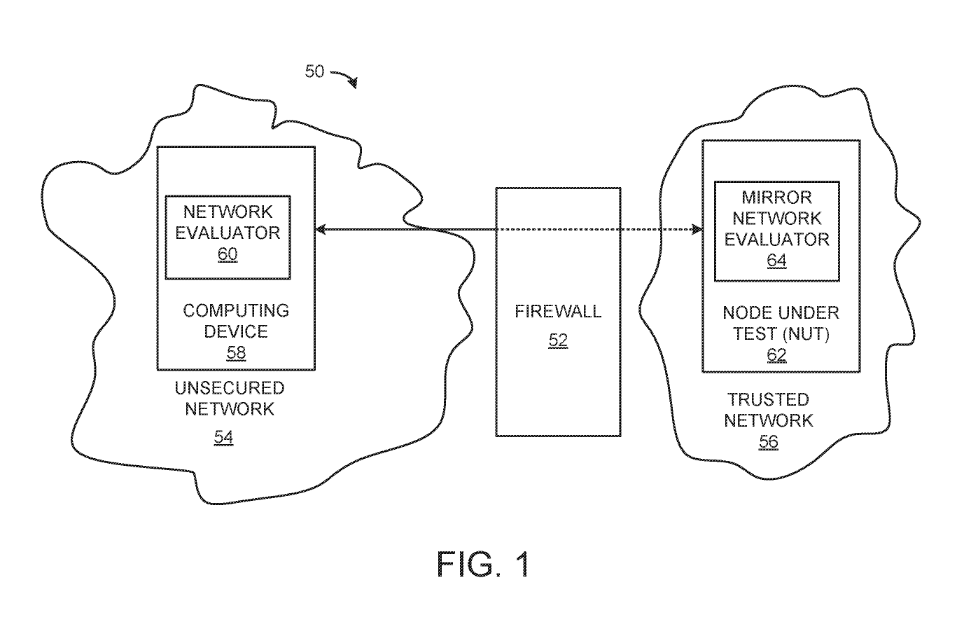

FIG. 1 illustrates an example of a network 50 that includes components for testing security on the network 50. The network 50 can include a firewall 52 that can be logically (and physically) coupled between an unsecured network 54 and a trusted network 56. The unsecured network 54 can be, for example, a public network, such as the Internet, and the trusted network 56 can be a private network, such as a local area network (LAN). Nodes on both the unsecured network 54 and the trusted network 56 can employ a standard communication protocol such as the Transmission Control Protocol/Internet Protocol (TCP/IP), including the Internet Protocol version 4 (IPv4) and/or the Internet Protocol version 6 (IPv6). Additionally, in an alternative example, a switch (e.g., a layer 2 switch) with an access control list (ACL) can be implemented in place of (or in addition to) the firewall 52.

As used herein, the term “firewall” can refer to any network component that can enforce security provisions of network traffic flowing there through. For instance, the firewall 52 can be a standalone network appliance, software executing on a network node, a router with built-in firewall capabilities, etc. Additionally or alternatively, it is noted that a switch (e.g., a layer 2 switch) can enforce an ACL. For purposes of simplification of explanation, only the firewall 52 is illustrated in the figures of this disclosure. However, it is to be understood that other network components (including the switch enforcing the ACL) could be implemented in addition to (or in place of) the firewall 52 and tested in the manner described herein. The firewall 52 can be implemented as a network security system that monitors and controls the incoming and outgoing network traffic between the unsecured network 54 and the trusted network 56 based on predetermined security rules. In this manner, the firewall 52 can operate as a portal/interface between the unsecured network 54 and the trusted network 56. In particular, the firewall 52 can enforce the security rules of the firewall 52 to restrict communication between nodes of the trusted network 56 and the unsecured network 54 to a set of predetermined protocols from the Internet Protocol suite and ports. For instance, the security rules of the firewall 52 can allow network traffic for a web page, the Remote Desktop Protocol (RDP), Domain Name Service (DNS), etc. Ports open on the firewall for communication from the unsecured network 54 to the trusted network 56 can be referred to as ingress ports. Ports open for communication through the firewall 52 from nodes on the trusted network 56 to nodes on the unsecured network can be referred to as egress ports.

A computing device 58 can be implemented as a node on the unsecured network 54. The computing device 58 could be implemented for example, by nearly any network node, including a desktop computer, a laptop computer, a tablet computer, a smartphone, etc. The computing device 58 can have a network evaluator 60 executing as application software. The network evaluator 60 can be implemented, for example, as a Network Enumeration and Reverification Distributed Sensor System (NERDSS) device. The network evaluator 60 can be configured to test an ability to establish communication with another node on the network 50.

The network evaluator 60 can have a test file that defines parameters for executing a series of network tests wherein the network evaluator 60 attempts to establish communication with another node on the network 50. Such parameters can include, for example a unique identifier (e.g., an IP address) of a particular node of the network 50. This node can be referred to as a node under test (NUT) 62. The parameters defined in the test file can also include a protocol type, a port number and a service request type.

In the present example, the NUT 62 is operating on the trusted network 56. In other examples, the NUT 62 can be any network node on the network 50. However, for purposes of simplification of explanation, it is presumed that the NUT 62 is a node on the trusted network 56. In this manner, the computing device can be considered to be logically positioned in front of the firewall 52 and the NUT 62 can be considered to be logically positioned behind the firewall 52.

Upon initiation/execution of a network test, (e.g., in response to user input or in response to a request from another system), the network evaluator 60 can attempt to establish communication with the NUT 62. As is illustrated in FIG. 1, such communication traverses the firewall 52.

In one mode of operation of the network evaluator 60 which mode can be referred to as an “open connection mode”, the NUT 62 does not need any software that detects execution of the network test. In the open connection mode, the network evaluator 60 can attempt to establish communication with the NUT 62 in a manner that should be allowed by the firewall 52 (e.g., through an ingress port of the firewall 52). In particular, the network evaluator 60 can check for TCP socket availability. For example, in the open connection mode, the network evaluator 60 can determine if a designated port is accessible via the TCP protocol, and in some instances, the network evaluator 60 can request a service through the designated port to ensure that the network evaluator 60 experiences expected results.

For instance, if the security rules of the firewall 52 specify that DNS is allowed at TCP/IP port 53 using the User Datagram Protocol (UDP), the test file of the network evaluator 60 may include parameters specifying that the network evaluator 60 is to request DNS to the NUT 62 at port 53. Thus, the network evaluator 60 can be configured to send a DNS request packet addressed to the NUT 62 on port 53. Any response to the DNS request packet can be recorded by the network evaluator 60 in a log file. For example, the network evaluator 60 can determine from a response packet (or the lack thereof after a predetermined amount of time, such as 5-10 seconds) whether the network evaluator 60 was able to establish communication with the NUT 62.

Additionally, the test file of the network evaluator 60 can include details on other ports and/or protocols that the network evaluator 60 can employ to attempt to establish communication with the NUT 62. For example, the test file may include a list of ports and/or protocols for the network evaluator 60 to test. In this situation, the network evaluator 60 can send packets using the various combinations of protocols and/or ports defined in the configuration protocol to attempt to establish communication with the NUT 62. Additionally, the results of each attempt at establishing communication (e.g., failure or success) can be recorded in the log file of the network evaluator 60.

In this manner, a review of the log file of the network evaluator 60 can indicate if bi-directional is established between the network evaluator 60 and the NUT 62, and the protocol and port for such bi-directional communication in the open connection mode. For instance, if the log file of the network evaluator 60 indicates that a DNS response is received by the network evaluator 60, then bi-directional communication was established over a particular port using a particular protocol.

In another mode of operation of the network evaluator 60, which can be referred to as a “mirror connection mode”, the NUT 62 includes a mirror network evaluator 64. The mirror network evaluator 64 can be a software application (e.g., an “app”) executing on the NUT 62. In some examples, the mirror network evaluator 64 can be the same program as the network evaluator 60. Additionally, the mirror network evaluator 64 can include a different (or the same) test file as the network evaluator 60.

In the mirror connection mode, the network evaluator 60 can attempt to establish communication with the mirror network evaluator 64 of the NUT 62 in a manner that should be allowed by the firewall 52 (e.g., through an ingress port). In particular, parameters defined in the test file of the network evaluator 60 can specify a type of protocol and a port for the network evaluator 60 to test. In such a situation, the network evaluator 60 can send a crafted packet (e.g., a specially formatted packet) that contains (e.g., in a payload) a random series of characters to the mirror network evaluator 64 of the NUT 62 in the protocol and port defined in the test file.

Upon receiving the crafted packet, the mirror network evaluator 64 can record the reception of the crafted packet in a log file. Additionally, the mirror network evaluator 64 copy the payload of the crafted packet and generate a response packet for the network evaluator 60. The response packet can be in the same (or different) protocol and on the same port as the crafted packet. The response packet can be received by the network evaluator 60, and the network evaluator 60 can record, in the log file, that successful bi-communication has been established with the NUT 62.

In a situation where no response packet is received, due to either the mirror network evaluator 64 not receiving the original crafted packet or the network evaluator 60 not receiving the response packet (after the response packet was sent by the mirror network evaluator 64), the network evaluator can record, in the log file, that no communication was established between the network evaluator 60 and the NUT 62.

Additionally, the test file of the network evaluator 60 can include details on other ports and/or protocols that the network evaluator 60 can employ to attempt to establish communication with the mirror network evaluator 64 of the NUT 62. For example, the test file may include a list of ports and/or protocols for the network evaluator 60 to test. In this situation, the network evaluator 60 can send crafted packets using the various combinations of protocols and/or ports defined in the configuration protocol to attempt to establish communication with the mirror network evaluator 64 of the NUT 62. The results of each attempt at establishing communication (e.g., failure or success) can be recorded in the log file of the network evaluator 60. Additionally, the mirror network evaluator 64 can record reception of each of the crafted packets.

In this manner, a review of the log file of the network evaluator 60 and the mirror network evaluator 64 can indicate if bi-directional or one-way communication is established between the network evaluator 60 and the NUT 62, and the protocol and port for such one-way or bi-directional communication. For instance, if the log file of the network evaluator 60 indicates that a response packet was received (in response to a crafted packet), then bi-directional communication was established over a particular port using a particular protocol. Additionally, if the log file of the network evaluator 60 indicates that no response packet is received, but the log file of the mirror network evaluator 64 indicates that a crafted packet was received (indicating that a response packet was generated and sent to the network evaluator 60), then one-way communication has been established between the network evaluator 60 and the NUT 62 on a particular port using a particular protocol.

The log files can be reviewed to identify security holes (e.g., unexpected points of ingress or egress on the network 50). Additionally, the log files can be employed to verify that the security rules of the firewall 52 (or an ACL of a switch) are set-up properly.

By employment of the network evaluator 60 and in some situations the mirror network evaluator 64, security of the network 50 can be tested. Thus, an initial setup or changes to the security rules of the firewall 52 (or on other network components, such as an ACL of a switch) can be periodically or intermittently tested.

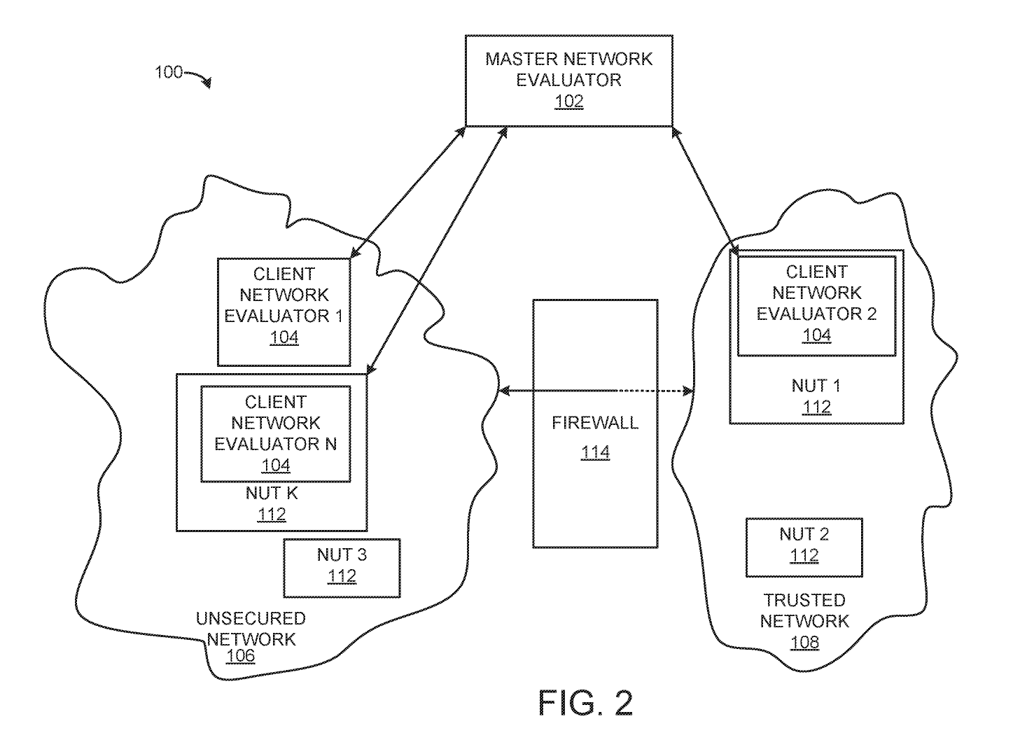

FIG. 2 illustrates another example of a network 100 that includes components for testing security of the network 100. The network 100 can include a master network evaluator 102 is communicatively coupled to N number of client network evaluators 104, where N is an integer greater than or equal to one. Each of the master network evaluator 102 and the N number of client network evaluators 104 can be implemented as Network Enumeration and Reverification Distributed Sensor System (NERDSS) devices. The network 100 can include, for example, an untrusted network 106 (e.g., a public network, such as the Internet) and a trusted network 108 (e.g., a LAN). In other examples, other network configurations are possible for the network 100.

The master network evaluator 102 and the N number of client network evaluators 104 can be implemented as a software application (e.g., an app) executing on one or more computing devices. In some instances, master network evaluator 102 and the N number of client network evaluators 104 can be implemented on a distributed computing system (e.g., a cloud server) or on individual network nodes. The master network evaluator 102 and the N number of client network evaluators 104 can be representative of stand-alone network nodes or as nodes where other software executes in parallel/concert with the corresponding master network evaluator 102 or client network evaluator 104. Additionally, for purposes of simplification of explanation, the master network evaluator 102 and the N number of client network evaluators 104 are show as operating on separate nodes of the network 100. However, it is to be understood that in some examples, operations of the master network evaluator 102 and operations of one client network evaluator 104 can be integrated together. For instance, in some situations, the master network evaluator 102 and the first client network evaluator 104 (client network evaluator 1), may be implemented on the same network node.

The master network evaluator 102 and the N number of client network evaluators 104 can be configured to test K number of nodes on the network 100, which nodes can be referred to as Nodes Under Test (NUTs) 112. Each of the K number of NUTs 112 can be implemented as a computing device, including a router, a computer, a network appliance, etc. In one given example (hereinafter, “the given example”), the first NUT 112 (NUT 1) can include the second client network evaluator 104 (Client Network Evaluator 2) executing thereon. Similarly, in the given example, the Kth Nut 112 (NUT K) has the Nth client network evaluator 104 (client network evaluator N) executing thereon. However, it is to be understood that the NUTs 112 and the client network evaluators 104 can be configured in a nearly limitless variety of ways.

The master network evaluator 102 can establish bi-directional communication with each of the N number of client network evaluators 104. In some examples, communications between the master network evaluator 102 and the N number of client network evaluators 104 can be conducted over a network external to the network 100 (e.g., a carrier network). In other examples, some (or all) of the communications between the master network evaluator 102 and the N number of client network evaluators 104 can be conducted over the network 100.

A firewall 114 can provide an ingress and/or an egress port between the unsecured network 106 and the trusted network 108. The firewall 114 can be implemented in similar manner as the firewall 52 illustrated in FIG. 1. Thus, the firewall 114 can include security rules (e.g., a rule set) for packets (e.g., protocol type and port number) passing through the firewall 114. It is noted that in some examples, a switch with an ACL can additionally or alternatively be implemented and tested on the network 100. However, for purposes of simplification of explanation, only the firewall 114 is illustrated and described in detail.

The master network evaluator 102 can include a network rules file that can be generated (e.g., in response to user input). The network rules file can define security rules and include data characterizing architecture of the network 100. The network rules file can be employed to generate test files for each of the N number of client network evaluators 104. In some examples, the master network evaluator 102 can generate the network rules file based on user input that characterizes the security rules of the firewall 114.

In the given example, the rule set of the firewall 114 designates an open egress port (e.g., port 80) for packets conforming to the Hyper Text Transfer Protocol (HTTP) to a network node that includes the first NUT 112. In such a situation, the master network evaluator 102 can be configured to generate a customized (or generic) test file for each of the N number of client network evaluators 104.

Each test file can be tailored for each of the N number of client network evaluators 104. Additionally, each test file can include parameters that specify a series of commands to initiate network test (and/or a series of network tests) that attempt to establish communication with another network node. In the given example, the network test file generated for the first client network evaluator 104 (client network evaluator 1) can include parameters specifying an HTTP query at port 80 to the second client network evaluator 104 operating on the first NUT 112. Additionally, the network test file for the first client network evaluator 104 can include parameters for sending packets using other protocols on port 80 and/or other protocols on other ports. For instance, well-known ports such as port numbers between 0-1023 (or some subset thereof) can be specified in the test file. Additionally, in environments where more rigorous testing is needed, the parameters for additional ports, up to the full 65,535 different ports supported by the TCP protocol can be tested.

Additionally, in the given example, the test file for the first client network evaluator 104 can include parameters (e.g., protocols and/or ports to test for communication with NUTs 2-K). For instance, in the given example, the second NUT 112 (NUT 2) does not include a client network evaluator executing thereon. In such a situation, the network test file for the first client network evaluator 104 could include parameters (e.g., a protocol and port) for attempting to establish communication with the second NUT 112, such as a DNS request on port 53.

Additionally, in the given example, the first and Nth client network evaluators 104 are operating on the unsecured (e.g., public) network 106 (e.g., “in front of the firewall 114”) and the second client network evaluator 104 is operating on the trusted network 108 (e.g., “behind the firewall 114”). As illustrated in FIG. 2, the N number of client network evaluators 104 can be scattered throughout the network 100 to test the security of the network 100 at multiple points. Similarly, the NUTs 112 that can also be scattered throughout the network 100.

Upon generation, the master network evaluator 102 can transmit the test files for each of the N number of client network evaluators 104. Additionally, the master network evaluator 102 can send a command causing each of the N number of client network evaluators (or some subset thereof) to initiate a network test in a manner prescribed by the corresponding received test file.

In the given example, it is presumed that the first client network evaluator 104 attempts to establish communication with each of the K number of NUTs 112 scattered throughout the network 100, including the unsecured network 106 and the trusted network 108. In the given example, the first client network evaluator 104 can attempt to establish communication with the second client network evaluator during operation in a “mirror connection mode”. In particular, in the given example, the first client network evaluator 104 can generate an HTTP request packet (e.g., a crafted packet) on port 80 addressed to the second client network evaluator 104 operating on the first NUT 112 that contains a random set of characters in the payload. The first client network evaluator 104 can record the sending of the packet in a local log file. If the second client network evaluator 104 receives the HTTP request packet from the first client network evaluator 104, the second client network evaluator 104 can generate a response packet (e.g., in the HTTP format) that includes the same payload (e.g., the random characters) and send the response packet to the first client network evaluator 104. The second client network evaluator 104 can record the sending of the response packet in a local log file. If the first client network evaluator 104 receives the response packet, the first client network evaluator 104 can confirm that two-way communication with an HTTP packet on port 80 was established with the second client network evaluator 104, and the confirmation can be stored in the local log file of the first client network evaluator 104. Conversely, if the first client network evaluator 104 does not receive the response packet within a particular timeframe (e.g., 5 seconds) the first client network evaluator 104 can record a lack of establishment of two-way communication with the first NUT 112.

Similarly, the first client network evaluator 104 can attempt to make contact with the second client network evaluator 104 using different protocols and/or different ports and record the sending of request packets, and the receipt of any response packets that would indicate a success of establishing two-way communication with the second client network evaluator 104.

Continuing with the given example, the test file of the first client network evaluator 104 can include parameters for attempting to establish communication with the second NUT 112 while operating in an “open connection mode”, since the second NUT 112 does not include a client network evaluator 104 executing thereon. Thus, in this situation, the network test file of the client network evaluator 104 can specify a particular service to request (e.g., DNS or other ubiquitous service) and a specific port (e.g., port 53) from the second NUT 112. The first client network evaluator 104 can generate a packet (e.g., a crafted packet) with a request for the specified service on the specific port addressed to the second NUT 112. The first client network evaluator 104 can record the sending of the packet with the request for the specified service at the specified port. If the first client network evaluator 104 receives a response from the second NUT 112, the first client network evaluator 104 can record (in the local log file) that two-way communication has been established with the second NUT 112.

Conversely, if the first client network evaluator 104 does not receive a response packet from the second NUT 112 within a predetermined amount of time (e.g., 5-10 seconds), the first client network evaluator 104 can record (in the local log file) that two-way communication has not been established with the second NUT 112.

Similarly, the network test file of the first client network evaluator 104 can specify other protocols/services and/or ports for attempting to establish communication with the second NUT 112. The results of each such attempt can be recorded in the log file of the first client network evaluator 104. Additionally, the first client network evaluator 104 can attempt to establish communication with other NUTs 112 that are specified in the network test file of the first client network evaluator 104 in a manner prescribed therein, such as a specific protocol, on a specific port and in a specific mode of operation (e.g., mirror mode or open connection mode).

Each of the remaining client network evaluators 104 (client network evaluators 2-N) can operate in a similar manner. That is, each client network evaluator 104 can attempt to establish communication with each of the NUTs 112 identified in a respective network test file and in the manner prescribed by the network test file. Additionally, each of the client network evaluators 104 can record (i) each attempt to establish communication (ii) each receipt of a request to establish communication and (ii) each result of each attempt to establish communication. TABLE 1 illustrates example data that be included in the log file for the first client network evaluator 104 for the given example. In TABLE 1, each communication event (labeled in TABLE 1 as “EVENT TYPE”) is recorded. Additionally, if the event type includes the sending of a request (e.g., a packet), the a unique identifier (ID) of a NUT 112 is stored in a destination address (labeled in TABLE 1 as “DESTINATION ADDRESS”) field. The unique ID could be, for example, an IP address, a fully qualified domain name (FQDN), a media access control (MAC) address, etc. Additionally, in TABLE 1, the protocol and port (labeled in TABLE 1 as “PROTOCOL” and “PORT”, respectively) associated with each event is also recorded. Further, in TABLE 1, the operation mode and time stamp (labeled in TABLE 1 as “OPERATION MODE” and “TIMESTAMP”, respectively) of each event is recorded.

TABLE 1

| | DESTINATION | | | | |
|---|---|---|---|---|---|
| EVENT TYPE | ADDRESS | PROTOCOL | PORT | OPERATION MODE | TIMESTAMP |
| SEND COMMUNICATION REQUEST 1 | UNIQUE ID | HTTP | 80 | MIRROR CONNECTION | TIME AND DATE |
| | OF NUT 1 | | | | |
| RECEIVE RESPONSE TO REQUEST 1 | UNIQUE ID | HTTP | 80 | MIRROR CONNECTION | TIME AND DATE |
| | OF NUT 1 | | | | |
| SEND COMMUNICATION REQUEST 1 | UNIQUE ID | FTP | 20 | MIRROR CONNECTION | TIME AND DATE |
| | OF NUT 1 | | | | |
| SEND COMMUNICATION REQUEST 2 | UNIQUE ID | DNS | 53 | OPEN CONNECTION | TIME AND DATE |
| | OF NUT 2 | | | | |
| SEND COMMUNICATION REQUEST 4 | UNIQUE ID | DNS | 53 | OPEN CONNECTION | TIME AND DATE |
| | OF NUT 3 | | | | |
| RECEIVE RESPONSE TO REQUEST 2 | | DNS | 53 | OPEN CONNECTION | TIME AND DATE |
| TIMEOUT FOR COMMUNICATION REQUEST 3 | | NONE | NONE | OPEN CONNECTION | TIME AND DATE |
| TIMEOUT FOR COMMUNICATION REQUEST 4 | | NONE | NONE | MIRROR CONNECTION | TIME AND DATE |
| RECEIVE COMMUNICATION REQUEST | | UDP | 123 | MIRROR CONNECTION | TIME AND DATE |
| FROM NUT K | | | | | |
| SEND COMMUNICATION RESPONSE TO NUT K | UNIQUE ID | UDP | 123 | MIRROR CONNECTION | TIME AND DATE |
| | OF NUT K | | | | |
| . . . | | | | | |

In some examples, the master network evaluator 102 can cause (e.g., signal) each of the N number of client network evaluators 104 (or some subset thereof) to run network tests specified in the network test file multiple times (e.g., periodically). In other examples, the master network evaluator 102 can cause (e.g., signal) each of the N number of client network evaluators 104 (or some subset thereof) to run network tests specified in the network test file asynchronously (e.g., in response to a specific command from the master network evaluator 102). Additionally, the master network evaluator 102 can update and re-send the network test files to each of the N number of client network evaluators 104 (or some subset thereof) in response to user input, such as user input indicating a change of the rule set in the firewall 114.

Each of the N number of client network evaluators 104 can send their respective log files to the master network evaluator 102. In some examples, each of the N number of network evaluators 104 can send their respective log files to the master network evaluator 102 upon completion of the testing. In other examples, each of the evaluators 104 can send their respective log files to the master network evaluator 102 incrementally in near real-time (e.g., within about 2 minutes) during the testing. In some examples, the log files can be sent in between network tests and in other examples, the log file can be sent after multiple network tests have been executed. The master network evaluator 102 can evaluate each of the N number of log files provided from the corresponding N number of client network evaluators 104 to generate a security report and/or a functionality repot that characterizes the security/functionality status of the network 100 and/or a functionality status of the network 100. In particular, the security report can identify protocols and ports and addresses through which communication can be established over the network 100. Additionally, in some examples, the security report can be compared against an expected list of protocols, ports and addresses allowed by the rule set in the firewall 114.

By implementing the master network evaluator 102 and the N number of client network evaluators 104, the security of the network 100 can be tested. In particular, it can be determined which nodes can communicate, and if each of the nodes can establish bi-directional communication or if the communication is limited to one-way communication. Additionally, due to the “server-client”/“master-slave” configuration of the master network evaluator 102 and the N number of client network evaluator 104, different points of the network 100 can be tested concurrently. The security report of the network 100 can be evaluated to determine if the rule set of the firewall 114 has been configured properly and/or if security holes (unintentional ingress or egress ports) exist. Additionally or alternatively, the security report and/or the functionality report can include a connection history of a given network connection. The connection history can include data characterizing times (e.g., by time stamps) that the given network connection is currently “up” or “down” (e.g., indicating whether the given network connection is functional). Thus, the connection history of the given network connection can indicate when a connection goes down and when the connection is re-established over the course of a network test. The connection history could be used, for example for scoring purposes in an educational setting.

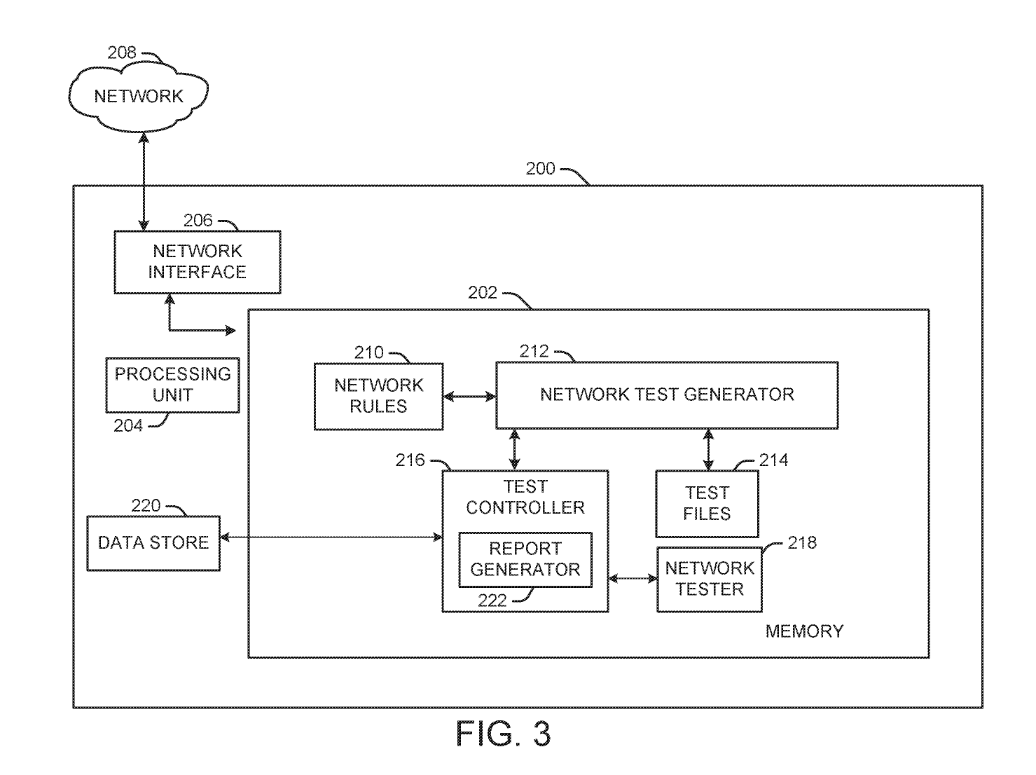

FIG. 3 illustrates an example of a network evaluator 200 for testing the security of a network. The network evaluator 200 can be employed, for example, to implement the network evaluator 60, the mirror network evaluator 64 of FIG. 1, one of the N number of client network evaluators 104 and/or the master network evaluator 102 of FIG. 2. The network evaluator can be implemented as a Network Enumeration and Reverification Distributed Sensor System (NERDSS) device. The network evaluator 200 can include a memory 202 that can store machine readable instructions. The memory 202 could be implemented, for example, as non-transitory computer readable media, such as volatile memory (e.g., random access memory), nonvolatile memory (e.g., a hard disk drive, a solid state drive, flash memory, etc.) or a combination thereof. The network evaluator 200 can also include a processing unit 204 to access the memory 202 and execute the machine-readable instructions. The processing unit 204 can include, for example, one or more processor cores. The network evaluator 200 can include a network interface 206 configured to communicate with a network 208. The network interface 206 could be implemented, for example, as a network interface card. The network 208 could be implemented, for example, as a private network (e.g., local area network or a carrier network) as a public network (e.g., the Internet), or a combination thereof (e.g., a virtual private network).

Additionally, in some examples, the network evaluator 200 can be implemented with multiple network interfaces 206 that connect to different networks 208. For example, in some situations, the network evaluator 200 can have separate connections to a public network (e.g., the Internet) and a private network (e.g., a carrier network). In this manner, the network evaluator 200 can communicate with other network evaluators via two separate networks, particularly in situations where one of the two such networks 208 has security rules that would otherwise prevent the network evaluator 200 from communicating with another network evaluator.

The network evaluator 200 could be implemented, for example in a computing cloud. In such a situation, features of the network evaluator 200, such as the processing unit 204, the network interface 206, and the memory 202 could be representative of a single instance of hardware or multiple instances of hardware with applications executing across the multiple of instances (i.e., distributed) of hardware (e.g., computers, routers, memory, processors, or a combination thereof). Alternatively, the network evaluator 200 could be implemented on a single dedicated computing node (e.g., a server, a router, an end-user computer, a network appliance, etc.).

The network evaluator 200 can receive network rules 210 that are stored in the memory 202. In some examples, the network rules 210 can be received, for example, in response to user input. In other examples, the network rules 210 can be received from another entity via the network 208. The network rules 210 can define a specific set of security rules that are to be tested on a network, such as the network 50 of FIG. 1 and/or the network 100 of FIG. 2. The network rules 210 can, for example, characterize a rule set of a firewall, such as the firewall 52 of FIG. 1 and/or the firewall 114 of FIG. 2. Additionally, the network rules 210 can include data characterizing architecture of the network 208 (the network being tested).

The memory 202 can include a network test generator 212 that can evaluate the network rules 210. The network test generator 212 can generate M number of test files for M number of corresponding network evaluators, where M is an integer greater than or equal to one. In some examples, the network evaluator 200 can be one of the M number of network evaluators, and in other examples, the network evaluator 200 can be implemented as a separate master network evaluator.

In either situation, each of the M number of test files 214 can include parameters for a series of network tests wherein during each network test, a network evaluator attempts to establish communication with another network node on a network (such as the network 208). As explained herein, the parameters for each of the network tests can be based on the network rules 210 including the security rules and the network architecture of the network 208. For instance, the network tests can specify a protocol/service request type, a port number and destination address for attempting to establish communication. As described herein, some of the network tests can test protocols and/or ports on the firewall that are supposed to be open (e.g., ingress ports). Additionally, some of the network tests can tests protocols and/or ports that are supposed to be closed, if the firewall (other network device) is configured properly.

Each of the M number of test files 214 can be tailored for a specific network evaluator. The tailoring can be based, for example, on a logical and/or physical location of each network evaluator. For instance, network evaluators outside (e.g., “in front of”) the firewall may have different tests run than network evaluators within the firewall.

The memory 202 can include a test controller 216 that can distribute (e.g., send) the M number of test files 214 to the respective network evaluators via the network 208, which may or may not be the same network being tested. In some examples, the test controller 216 can send a respective test file 214 to a network tester 218 of the memory 202, such that the network evaluator 200 can operate as a client network evaluator or a standalone network evaluator. Additionally, the test controller 216 can send a test initiation message to each of the M number of network evaluators (or some subset thereof) via the network 208, which causes each of the network evaluators to execute a network test prescribed in the corresponding test file 214. Similarly, the network tester 218 can also receive the test initiation message.

In response to the test initiation message, the network tester 218 can execute the network tests prescribed by the received test file 214. Additionally, the network tester 218 can record each attempt to establish communication (e.g., send a packet) to another network evaluator (e.g., in a mirror mode of operation) or other network node (e.g., in an open mode of operation) in a log file. Similarly, the network tester 218 can record an indication of success or failure to establish the communication (e.g., based on reception of a response) in the log file. Further still, the network tester 218 can record each packet received via the network 208 from another network evaluator attempting to establish communication with the network evaluator 200. Moreover, the network tester 218 can respond to each such request with a request packet that is sent via the network 208, and the sending of the response can be recorded in the log file. In this manner, the log file of the network tester 218 can be similar to the log file illustrated in TABLE 1. The log file can be provided to the test controller 216.

Additionally, the test controller 216 can receive log files from each of the M number of network evaluators (or some subset thereof). The test controller 216 can store the log files in a data store 220 (e.g., a non-transitory machine readable medium), such as a database or other data structure. Additionally, the test controller 216 can include a report generator 222 that can parse through the received log files to generate a security report. The security report can be stored in the data store 220, provided another network node via the network 208 and/or output via a graphical user interface (GUI).

In some examples, the security report can be an aggregated version of a plurality of log files that have been recorded for a particular network test or series of tests. In other examples, the security report can be a simplified report that can give an indication of ingress and egress points in the network 208.

Additionally, in some examples, the test controller 216 can cause each of the M number of network evaluators (and/or the network tester 218) to periodically (e.g., per hour, day, week, month, etc.) execute the network tests based on the respective test files 214. In this situation, the report generator can generate multiple security reports, and in some situations, the report generator 222 can identify changes to the security of the network 208.

In this manner, the network evaluator 200 can be employed to test the security settings of devices (including the firewall) of the network 208. Moreover, since the network evaluator 200 can (in some examples) communicate with other client network evaluators via the network 208, the security of the network 208 can be tested from multiple logical and/or physical points. Security reports generated by the report generator 222 have many uses, including testing initial security settings of a network device (e.g., testing of the setting up of a firewall), detecting hacking (e.g., detecting unexpected changes to the security of the network 208), detecting security holes in the network 208 (e.g., unexpected points of ingress and/or egress), etc.

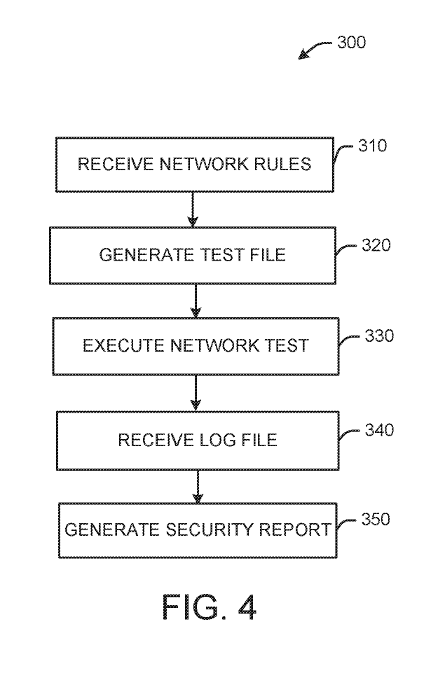

In view of the foregoing structural and functional features described above, example methods will be better appreciated with reference to FIG. 4. While, for purposes of simplicity of explanation, the example method of FIG. 4 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method. The example method of FIG. 4 can be implemented as instructions stored in a non-transitory machine-readable medium. The instructions can be accessed by a processing resource (e.g., one or more processor cores) and executed to perform the methods disclosed herein.

FIG. 4 illustrates a flowchart of an example method 300 for testing a network, such as the network 50 illustrated in FIG. 1, the network 100 illustrated in FIG. 2 and/or the network 208 illustrated in FIG. 3. The method 300 can be implemented, for example, by a network evaluator, such as the network evaluator 60 illustrated in FIG. 1, the client network evaluator 104 and the master network evaluator 102 of FIG. 2 and/or the network evaluator 200 illustrated in FIG. 3. At 310, the network evaluator can receive network rules (e.g., the network rules 210 of FIG. 3) that characterizes security rules and network architecture of a network to be tested. At 320, a test file for the network evaluator can be generated based on the network rules. The test file can include parameters for a series of network tests to execute to test the security of the network. In some examples, the network evaluator can generate a plurality of individual test files that can be sent to external network evaluators.

At 330, a network test can be executed based on the test file. The results of the test file can be stored in a log file. At 340, the network evaluator can receive a log file from other network evaluators (e.g., client network evaluators). At 350, the log files can be analyzed to generate a security report that characterizes the security features of the network being tested.

In view of the foregoing structural and functional description, those skilled in the art will appreciate that portions of the systems and method disclosed herein may be embodied as a method, data processing system, or computer program product such as a non-transitory computer readable medium. Accordingly, these portions of the approach disclosed herein may take the form of an entirely hardware embodiment, an entirely software embodiment (e.g., in a non-transitory machine readable medium), or an embodiment combining software and hardware. Furthermore, portions of the systems and method disclosed herein may be a computer program product on a computer-usable storage medium having computer readable program code on the medium. Any suitable computer-readable medium may be utilized including, but not limited to, static and dynamic storage devices, hard disks, solid-state storage devices, optical storage devices, and magnetic storage devices.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processors of a general purpose computer, special purpose computer, or other programmable data processing apparatus (or a combination of devices and circuits) to produce a machine, such that the instructions, which execute via the one or more processors, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

What have been described above are examples. It is, of course, not possible to describe every conceivable combination of structures, components, or methods, but one of ordinary skill in the art will recognize that many further combinations and permutations are possible. Accordingly, the invention is intended to embrace all such alterations, modifications, and variations that fall within the scope of this application, including the appended claims. Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A computing device executing a given network evaluator, the given network evaluator being configured to:
execute a network test based on a test file, wherein the execution of the network test comprises:
attempting to establish bi-directional communication with another network evaluator over a network employing a plurality of different ports and protocols specified in the test file; and
recording a success or failure of the attempting in a log file.

2. The computing device of claim 1, wherein the given network evaluator and the other network evaluator are logically separated by a firewall with a rule set that defines security rules of the firewall.

3. The computing device of claim 1, wherein execution of the network test further comprises:
requesting a service from a network node across the network; and
recording a receipt of a response to the request or a timeout in the log file.

4. The computing device of claim 1, wherein the given network evaluator and the other network evaluator are logically separated by a network device comprising one of a switch and a router, wherein the network device is configured to enforce an Access Control List (ACL) that defines permissions of network traffic passing through the network device.

5. A master network evaluator comprising one or more computing devices, the master network evaluator being configured to:
receive a set of network rules that characterizes security settings of a network and architecture of the network;
generate a plurality of test files that each characterizes parameters for a series of network tests based on the network rules;
providing each of the plurality of test files to a respective client network evaluator of a plurality of client network evaluators; and
receive a plurality of log files that each characterizes a network test executed by each of the plurality of network evaluators.

6. The master network evaluator of claim 5, wherein a given client network evaluator and another client network evaluator of the plurality of client network evaluators are separated by a firewall.

7. The master network evaluator of claim 6, wherein the parameters of a given test file for the given network evaluator defines a given network test implementing a particular protocol on a particular port that is defined as an ingress or egress port on the firewall.

8. The master network evaluator of claim 7, wherein the parameters of the given test file for the given network evaluator further defines a given network test implementing a particular protocol on a particular port that is not defined as an ingress or egress port on the firewall.

9. The master network evaluator of claim 6, wherein the parameters of a given test file for the given network evaluator further defines the other client network as a destination for a request packet.

10. The master network evaluator of claim 6, wherein the parameters of a given test file for a given network evaluator of the plurality of network evaluators defines a given network test implementing a particular request for service from another node on the network on a particular port, wherein the given network evaluator and the other node are separated by a firewall, wherein the particular port is defined as an ingress or egress port on the firewall.

11. The master network evaluator of claim 6, wherein the parameters of a given test file for a given network evaluator of the plurality of network evaluators further defines a another network test implementing another particular request for service from the other node on the network on another particular port, wherein the other particular port is not defined as an ingress or egress port on the firewall.

12. The master network evaluator of claim 5 being further configured to generate a security report for the network based on the plurality of log files.

13. The master network evaluator of claim 5 being further configured to cause each of the plurality of client network evaluators to periodically execute the network test.

14. The master network evaluator of claim 5, wherein each of the plurality of log files includes results of an attempt to establish bi-directional communication with another node on the network.

15. The master network evaluator of claim 5, wherein each of the plurality of log files includes results of an attempt to establish bi-directional communication with another node on the network.

16. A network comprising:
a master network evaluator comprising one or more computing devices, wherein the master network evaluator includes network rules that define security rules of a firewall on the network and architecture of the network;
a given client network evaluator comprising a computing device that is in communication with the master network evaluator via the network, wherein the given client network evaluator is logically positioned in front of the firewall; and
another client network evaluator comprising a computing device in communication with the master network evaluator, wherein the other client network evaluator is logically positioned behind the firewall;
the master network evaluator being configured to:
generate a given test file for the given client network evaluator based on the network rules, wherein the given test file defines parameters for network tests for establishing communication with other network nodes over a plurality of different protocols and ports traversing the firewall;
generate another test file for the other client network evaluator based on the network rules, wherein the given test file defines parameters for network tests for establishing communication with other network nodes over a plurality of different protocols and ports traversing the firewall;
signal the given client network evaluator to execute a series of network tests based on the given test file; and
signal the other client network evaluator to execute another series of network test based on the other test file.

17. The network of claim 16, wherein the given client network evaluator and the other client network evaluators are each configured to:
record results of the network tests in a respective log file; and
provide the respective log files to the master network evaluator.

18. The network of claim 17, wherein the master network evaluator is further configured to generate a security report for the network based on the log files received from the given client network evaluator and the other client network evaluator.

19. The network of claim 18, wherein the security report identifies a security hole in the network.

20. The network of claim 18, wherein the master network evaluator is further configured to generate a functional report for the network based on the log files received from the given client network evaluator and the other client network evaluator, wherein the functional report identifies a connection history for a connection between the given client network evaluator and the other client network evaluator.
